(19) United States
(12) Patent Application Publication
(10) Pub. No.: US 2015/0317670 A1
(43) Pub. Date: Nov. 5, 2015

(54) DYNAMIC MARKETING RESOURCE ARBITRAGE

(71) Applicant: Adobe Systems Incorporated, San Jose, CA (US)

(72) Inventors: David Cavander, Pleasanton, CA (US); Anil Kamath, Los Altos Hills, CA (US); Siddharth Shah, San Francisco, CA (US); Kunal Jain, Chennai (IN)

(73) Assignee: ADOBE SYSTEMS INCORPORATED, San Jose, CA (US)

(21) Appl. No.: 14/267,319

(22) Filed: May 1, 2014

(51) Int. Cl. G06Q 30/02

(52) U.S. Cl. CPC G06Q 30/0242

(57) ABSTRACT

Techniques are disclosed for generating a forward-looking, goal seeking marketing plan that links prior media purchase transactions to predicted future financial results for a brand, product market, or campaign. A computing device is configured to receive input data associated with one or more marketing elements, such as television ads, print ads, and online ads. From the input data, response factors corresponding to each marketing element can be calculated. These response factors can be used to generate a model upon which future marketing transactions can be planned in accordance with scenarios associated with a particular marketing campaign. A marketing plan can be generated from the model in which some or all marketing elements are ordered in a flighting schedule that provides optimum financial results for a selected scenario.

### FIELD OF THE DISCLOSURE

This disclosure relates to the field of data processing, and more particularly, to techniques for automatically generating a forward-looking, goal-seeking marketing plan.

### BACKGROUND

Marketing is the process of providing information regarding products or services to customers for the purpose of influencing purchasing behavior. Marketing can be accomplished through a variety of communication channels, including, for example, print, television, radio, online, outdoor (e.g., billboard), the Internet, cellular, mail, and in-store promotions, using a variety of techniques (e.g., advertising, product placement, promotions, etc.). Research has revealed that, in many cases, contact of a customer with a single marketing channel is insufficient to produce the desired volume of sales. Thus, to increase sales, multiple channels may be used in conjunction with a particular marketing campaign. For example, some percentage of a marketing budget may be allocated to television, another percentage to contextual advertising (e.g., where a seller pays for advertisements displayed in response to certain search terms entered on a web site), and the remaining percentage to direct mail. However, costs and effectiveness can vary significantly not only from one channel to another, but also with respect to their sequencing and relative effects on each other. Consequently, it may be desirable to allocate marketing expenditures in proportion to the channels that are predicted to be most effective and are consistent with particular spending and sales goals for the corresponding campaign, brand or product. However, it is insufficient to analyze any particular form of marketing in isolation. Owing in part to the proliferation of many new marketing channels (e.g., web- and social media-based channels), it is becoming increasingly complex to assess the relationship between marketing campaigns, marketing channels and customer behavior. Furthermore, existing decision making tools do not allow marketing planners to optimally allocate the use of a marketing budget to several different types of media (e.g., print, television, online, etc.) across different dimensions (e.g., brands, local markets, marketing campaigns and time frames). As a result, it is common for such decisions to be made on the basis of limited, subjective, or incomplete information, which in many cases produces disadvantageous results.

### BRIEF DESCRIPTION OF THE DRAWINGS

The accompanying drawings are not intended to be drawn to scale. In the drawings, each identical or nearly identical component that is illustrated in various figures is represented by a like numeral.

FIG. 1 illustrates an example client-server computing architecture configured in accordance with an embodiment of the present invention.

FIG. 2 is a block diagram representing an example computing device that can be used in conjunction with an embodiment of the present invention.

FIG. 3 illustrates an overview of an example methodology generating a marketing plan that may be used in conjunction with various embodiments of the present invention.

FIG. 4 illustrates a flow diagram of an example user workflow, in accordance with an embodiment of the present invention.

FIGS. 5-11 are examples graphical user interfaces, in accordance with various embodiments of the present invention.

FIG. 12 is a flow diagram showing an example methodology for generating a forward-looking, goal-seeking marketing plan, in accordance with an embodiment.

### DETAILED DESCRIPTION

Numerous factors can affect the effectiveness of a particular marketing campaign on sales, such as the sequence in which advertisements are scheduled to appear and the intervals of such appearances. Further complicating matters are the effects of cross-channel marketing efforts, in which, for example, advertisements appearing in one or more channels (e.g., television or print) have an influence—perhaps positive, negative or neutral—on the effectiveness of advertisements appearing in other channels (e.g., online or in-store). Existing planning tools do not take into account the complex interrelationships between the performance of prior marketing campaigns, the goals and budget of new marketing campaigns, and the effects of cross-channel marketing. For example, some existing solutions predict the conversion probability of only a single impression (e.g., an advertisement generated in response to appearance of a word or search term on a web page) at a particular point in time, and then compare the marginal revenue and cost of that impression with alternative impressions (e.g., different paid search words having different marginal revenues and costs) that are available, but not necessarily utilized, within the same marketing channel. Additionally, existing planning tools do not enable different users, such as brand owners, advertising agencies, and media publishers, to work collaboratively using a common workflow that is integrated with such tools, each of which performs a different type of operation.

To this end, and in accordance with an embodiment of the present invention, techniques are provided for generating a forward-looking, goal seeking marketing plan that links prior media purchase transactions to predicted future financial results for a brand, product market, or campaign. In one specific embodiment, a computing device is configured to receive input data associated with one or more marketing elements, such as television ads, print ads, and online ads. From the input data, response factors corresponding to each marketing element can be calculated. The response factors may represent, for example, the marginal profit or loss (e.g., adjusted revenue less actual cost) obtained from any given marketing element, or performance measures of other aspects of the marketing elements. These response factors can be used to generate a model upon which future marketing transactions can be planned in accordance with scenarios associated with a particular marketing campaign. The model may, for example, represent the performance or effectiveness of using various marketing channels for achieving a particular outcome. The scenarios can be user-supplied and may, for example, define the parameters of several dimensions, such as brands, local markets, campaigns and time frames. In a specific embodiment, a marketing plan can be generated from the model in which some or all marketing elements are ordered in a flighting schedule that provides optimum financial results for a selected scenario. In some embodiments, a set of technology integration enablers can be used by different entities, such as brand owners, advertising agencies and media publishers, to operate media transactions in an end-to-end manner (e.g., from planning and goal-setting to deployment). Numerous configurations and variations will be apparent in light of this disclosure.

As used herein, the term “flighting” refers to a sequence in which various marketing elements (e.g., advertisements, promotions, etc.) are scheduled to appear and the intervals between such appearances.

As used herein, the term “touchpoint” generally refers to a point of contact between a seller (e.g., of a product, service or brand) and a buyer (e.g., a customer, user, employee or stakeholder). A touchpoint can also be referred to as a marketing channel or marketing outlet that, in some cases, forms the interface between marketing campaign activities and buyer activities. Some non-limiting examples of touchpoints are print advertisements, television advertisements, radio advertisements, call centers, social media, search engines, in-store promotions, mail, online services, and sales staff.

As used herein, the term “elasticity” includes the percentage change in sales units for a product, service or brand as a result of a corresponding percentage change in media effort (e.g., spending) by touchpoint. The same causal or driver concept applies to other upper funnel, intermediate or final outcomes desired by a brand, and to non-media drivers such as the economy, pricing or sales force effort. Expressed in dollars, elasticity is the expected percentage marginal revenue response from a given media touchpoint. Touchpoints can be measured as impressions (the number of times a consumer is exposed to or interacts with a touchpoint), and each impression has a corresponding marginal cost.

As used herein, the term “result data” includes quantified results of customer interactions with one or more marketing elements. For example, the result data may represent how many times an advertisement or advertisements were presented to a consumer, when and how the advertisements were presented to the consumer (e.g., via newsprint, television, radio, telephone solicitation, direct mail, web, etc.), how many times the consumer interacted with an advertisement (e.g., clicked on an online advertisement, responded to an email advertisement, watched a video advertisement or portion thereof, responded to a telemarketing campaign, etc.) and the results of those consumer interactions, such as how much revenue the advertisement generated, whether the consumer purchased or rented an offering, watched an informational video, requested additional information about an offering related to the marketing campaign, and so on.

As used herein, the term “marketing element” includes a brand (e.g., trademarks or logos), product packaging, advertising (in any form of media), promotions, marketing events, marketing campaigns, marketing activities, and anything else that can be associated with the promotion of a product to consumers or buyers. Examples of marketing elements include newspaper advertisements, radio advertisements, television advertisements, in-store promotions (e.g., discounts or product tie-ins), web-based advertisements, social media promotions, telephone solicitations, direct mail advertisements, sponsorships, naming rights, and so forth. In some embodiments, quantifiable costs and benefits can be associated with individual marketing elements or groups of marketing elements in relation to individual buyers or aggregated groups of buyers.

As used herein, the term “response factor” represents any measure of the effectiveness of a marketing activity. Such effectiveness may be measured, for example, as the marginal profit or loss (e.g., adjusted revenue less actual cost) obtained from any given marketing element, or performance measures of other aspects of the marketing elements (e.g., the profit or loss of a campaigns, one or more touchpoints, a time period, a target audience, etc.). The response factor can be used as part of an analysis of the historical performance of any marketing activity or group of activities for future decision making (e.g., where the decision making process is implemented in a computer). For instance, if the response factor indicates a particular marketing effort has led to a financial loss under certain conditions (e.g., marketing channel, time, audience, etc.), the decision maker may decide to abandon a strategy involving similar conditions, or to modify the strategy in a particular way so as to prospectively improve the response factor for related future marketing activities. The response factor can be used for any purpose where the effectiveness of a certain marketing activity or set of marketing activities is relevant, such as for generating or updating a predictive model that is used at least in part for generating a marketing plan.

As used herein, the term “model” includes any mathematical logic (e.g., a set of objects having a collection of finitary operations, and relations defined on it), economic construct representing economic processes by a set of variables and a set of logical or quantitative relationships, simulation or other representation of a set of relationships or processes. For example, a model may include a deterministic, discrete, dynamic, distributed, machine learning or discriminative mathematical model (e.g., a Support Vector Machine). For a given set of inputs to the model, the model produces a finite set of outputs that can be used to predict or simulate the behavior of a given system. For example, a model can be generated based on the historical performance of a marketing activity, and, for a given set of constraints (such as cost, time, campaign, marketing channel, touchpoint, etc.), the model can be used to predict the future performance of another marketing activity based on the historical performance.

As used herein, the term “scenario data” defines, at least in part, a marketing campaign, a set of goals for the campaign, a set of constraints for the campaign, a time frame for the campaign, a set of desired marketing elements for the campaign, a desired mix of the marketing elements, a set of assumptions for the campaign, or any combination of these. In some cases, the scenario data includes a marketing goal, a budget constraint, a resource constraint and an economic assumption. In some cases, the scenario data can include a set of parameters, including a brand, a product, a touchpoint, a geographical market, a time frame, or any combination thereof. In some cases, scenario data can include a set of parameters, the parameters including a brand, a product, a touchpoint, a geographical market, or a time frame.

As used herein, the term “marketing plan scenario” includes scenario data associated with a particular marketing plan. In some cases, the marketing plan scenario can include scenario data associated with one or more marketing elements. For example, a marketing plan scenario can encompass scenario data associated with a given marketing channel, touchpoint, time frame, or other parameter either alone or in combination with other marketing elements. In some cases, several different marketing plan scenarios can be used in conjunction with various embodiments as described in this disclosure to produce different marketing plans, depending on the requirements of the user.

As used herein, the term “marketing plan” includes a scheduled allocation of a marketing budget to one or more different types of media (e.g., print, television, online, etc.) across one or more different dimensions (e.g., brands, local markets, marketing campaigns and time frames). For example, the marketing plan may allocate a certain percentage or fixed dollar amoung of the budget toward print advertising, and another percentage or dollar amount to social media. In some cases, the marketing plan can be used in conjunction with, or to determine, other considerations, such as a flighting schedule, where the allocation of the budget is coordinated with the time sequence in which the budget is to be spent (e.g., 30% of the budget in the first month of a campaign, 50% of the budget in the second month, and 20% of the budget in the third month).

As used herein, the term “marketing workflow” includes a process by which a marketing plan can be generated, revised, or updated. For example, a workflow may include establishing values for various scenario criteria, selecting a marketing campaign, brand or product, and executing a model against response factors for the selected campaign, brand or product using the scenario criteria.

Media and branding, as well as other factors such as in-store conditions, can help make a customer aware of a brand, provide information about a product, and deliver various calls to action, such offering a deal or price. Marketing elements can represent various dimensions, such as a brand, a location of an exposure to the impression, a prior stock of exposures and prior frequency of such exposures, a time and duration of the exposure, a message campaign or content, the characteristics of the media publisher used to provide the exposure, the characteristics of the target customer, or any combination of these. Different types of marketing elements may differ in their capacity to communicate brand images, information and calls to action.

In accordance with an embodiment, various types of data can be tagged, or associated, with one or more dimensions using, for example, a data dictionary and pre-defined data upload templates by industry vertical. This common tagging provides a standard data typing that enables automated assembly of an analytics data set. Various data types can be so tagged, including outcomes (e.g., upper funnel, unit sales, leads, new customers, and revenue), offline media (e.g., TV, print, radio, out-of-home (OOH), public relations, sponsorship, e-mail, call center, and catalog/direct marketing), online media (e.g., display, paid search, social (paid, earned), Internet video, mobile, devices, web traffic (owned), and queries), pricing, economy, and competition.

As will be appreciated in light of this disclosure, customers typically make purchase decisions for brands over an evolving time window, whether as a new first time purchase, repeat purchase or upgrade or downgrade. For example, a given customer may be exposed to two television ads for a product, three print ads, a public relations spot and six paid search words over a two-week period in which the customer makes one purchase of the product. Each marketing element can have a marginal response in terms of conversion probability or expected marginal revenue. Further, each marketing element can have a corresponding marginal cost that may vary by location, time, and publisher. Conversion probabilities (the likelihood that a given impression will lead to a sale) can also depend on factors such as the economy, product pricing and competitive share of voice (e.g., the percentage of the total advertising facing a customer). The elasticity associated with a marketing element can spike or decay over time, which represents a cascading impulse response for advertising media. Since different touchpoints can have different persuasive effects on customers, the effect of each marketing element on customer behavior can be weighted according to the respective elasticities. Furthermore, an ideal mix of marketing elements for a given scenario or set of marketing goals can be proportional to the respective elasticities.

According to an embodiment, a user can establish goals for a brand and a campaign, such as goals for growth in revenue or share, profit, product life stages (timing), campaigns and mix of marketing elements (e.g., percentage of each type of resource). In addition, brands may have constraints on budgets or resource (and media) line items. Profit, possibly limited by constraints, is defined as base profit plus the summation of the marginal profits from each marketing element utilized and the time lags involved. The expected, marginal profit “z” for any touch “v” is the corresponding marginal revenue (from the elasticity “e” times the floating base) less the marginal cost “c”. Each has dimensions for, e.g., the brand involved, location and time of the impression and transaction.

Once the goals have been established, a forward goal seeking algorithm can rank or sort the marketing elements by the corresponding incremental profit (or other goal results). Then, a marketing plan can be generated in which various marketing elements are selected to deploy in rank order and in time sequencing up to the point where marginal revenue by touchpoint equals marginal cost or stops when other constraints are applied. In this process, the algorithm trades-off marketing elements and their timing based on the goals and response factors. The same arbitrage logic can be applied to multiple products, multiple markets and multiple time periods. Accordingly, the goal seeking algorithm can deliver a marketing plan or budget in total, the mix by touchpoints and flighting schedules of impressions required by touchpoint, date and local market. These schedules can then be fed or passed to one or more of a plurality of executional paths and tools for media transactions by type of touchpoint.

In some embodiments, a backend platform can include a plurality of algorithms for determining elasticities or response weights (e.g., determining response factors based on marketing transactions and other drivers), such as ordinary least squares, step-wise regression, panel least squares, generalized least squares, logit models, error components and signal extraction, 2SLS, 3SLS, VAR, Bayesian classifiers and others. The backend can be configured to automate various steps in this process, including missing data and outlier detection, and applying business rules and statistical rules to the incoming data. Other factors for determining the elasticities or response weights include base volume, diminishing returns, resource synergies, control factors such as the economy, pricing and various interactions, time series stationarity, or any combination of these.

In some embodiments, using aggregated data and information about how marketing resources are currently allocated, the backend platform can use regression techniques to generate models that represent the performance or effectiveness of the various marketing channels on a particular business outcome or outcomes. Such so-called attribution models may represent the true impact or effect of advertising resource allocation decisions on a particular business outcome or outcomes. For instance, the backend platform may generate a model that relates advertising resource allocation decisions for different channels (e.g., the amount of money spent on advertising for each channel) to revenue for the advertiser. Thus, the models may describe how business outcomes respond to, or are impacted by, changes to underlying driver variables, such as the amount of marketing resources allocated to different marketing channels. Such response effects may be referred to as “lift factors.” The backend processor or other processes may use the lift factors to inform future marketing resource allocation decisions and dynamically improve the results of those decisions relative to a business outcome or outcomes.

In some embodiments, response factors for a particular business outcome may be modeled using advertising variables and other external factors or causal variables. For example, sales revenue may depend on the allocation of marketing resources to television media and search engine media along with other related external factors, such as the economy, distribution, pricing, awareness (e.g., number of followers on Twitter or friends on Facebook), page views of Facebook or other websites, and so on. The backend platform can collect, analyze, and incorporate data for each of these external factors into a cross-media attribution model to provide additional information regarding the true impact of marketing resource allocations on business outcomes. In some cases, a causal variable may be an intermediate outcome and be similarly modeled using its own causal variables. For example, search engine media, which is a causal variable for sales revenue in the example above, may have a number of its own causal variables, such as television media, paid search clicks, and so on. Thus, the performance or true impact of marketing resources allocated to search engine media can be modeled using the causal variables related to search engine media and used to generate a model for sales revenue. It will be understood that the causal variables for a particular outcome or intermediate outcome can be determined using any of a number of marketing science and consumer behavior paradigms. Additionally, other techniques, such as vector autoregressive methods, can be used to determine causal paths between user actions, intermediate outcomes, and final outcomes and any associated time lags (e.g., the time between a consumer seeing an advertisement on television and then performing an online search for that product or the time between a consumer performing an online search for a product and then purchasing that product online or in a store).

System Architecture

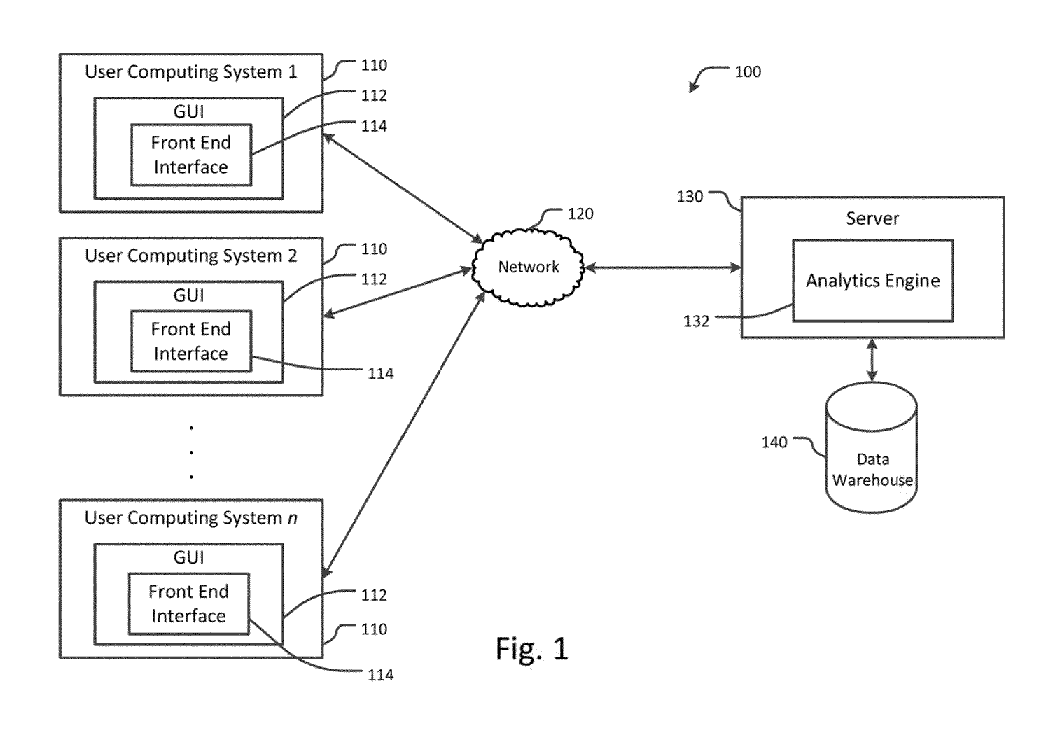

FIG. 1 illustrates an example client-server computing architecture 100 configured in accordance with an embodiment of the present invention. In this example, one or more user computing systems 110 each include a GUI 112 configured to provide a front end interface 114 and to interact electronically, via a communication network 120, with an analytics engine 132 hosted by a server 130. Although depicted in FIG. 1 as separate devices, it will be appreciated that in some embodiments the functionality of the user computing system 110 and the server 130 may be integrated into one computing environment; for example, the analytics engine 132 may be implemented locally on the user computing system 110. One or more data warehouses 140 operatively connected to the server 130 and the analytics engine 132 can be configured to store analytical data regarding the activities and interactions of one or more users with a website, and/or other data created and maintained by the analytics engine 132. The data warehouse 140 can be implemented, for example, with any suitable type of memory, such as a disk drive included in, or otherwise in communication with, the server 130. Other suitable memories include flash memory, random access memory (RAM), a memory stick or thumb drive, USB drive, cloud storage service, etc. In a more general sense, any memory facility can be used to implement the data warehouse 140. In some embodiments, one or more components of the architecture 100 can operate in a cloud environment, such as provided by Amazon Web Services™ (AWS) or other suitable collections of remote computing services. As used herein, a cloud refers to any client-server architecture in which at least some computation and/or data storage is relocated from a client computing system to one or more remote servers that provide the computation or data storage as a commodity or utility. A cloud may, for example, include a large collection of resources that can be interchangeably provisioned and shared among many clients.

As will be appreciated in light of this disclosure, the various modules and components shown in FIG. 1, such as the GUI 112, analytics engine 132 and data warehouse 140, can be implemented in software, such as a set of instructions (e.g., R and Revolution R programming languages, Python™ by Python Software Foundation, C, C++, object-oriented C, JavaScript, Java, BASIC, etc.) encoded on any computer readable medium or computer program product (e.g., hard drive, server, disc, or other suitable non-transient memory or set of memories), that when executed by one or more processors, cause the various methodologies provided herein to be carried out. It will be appreciated that, in some embodiments, various functions performed by the user computing system 110, the server 130, and data warehouse 140, as described herein, can be performed by similar processors and/or databases in different configurations and arrangements, and that the depicted embodiments are not intended to be limiting. Various components of this example embodiment, including the user computing systems 110 and/or server 130, can be integrated into, for example, one or more desktop or laptop computers, workstations, tablets, smartphones, game consoles, set-top boxes, or other such computing devices. Other componentry and modules typical of a computing system, such as processors (e.g., central processing unit and co-processor, graphics processor, etc.), input devices (e.g., keyboard, mouse, touch pad, touch screen, etc.), and operating system, are not shown but will be readily apparent. The network 120 can be any communications network, such as a user's local area network and/or the Internet, or any other public and/or private communication network (e.g., local and/or wide area network of a company, etc.). The GUI can be implemented using any number of known or proprietary browsers or comparable technology that facilitates retrieving, presenting, and traversing information resources, such as analytics information provided by the analytics engine 132 and/or web pages on a website, via a network, such as the Internet.

Example Computing Device

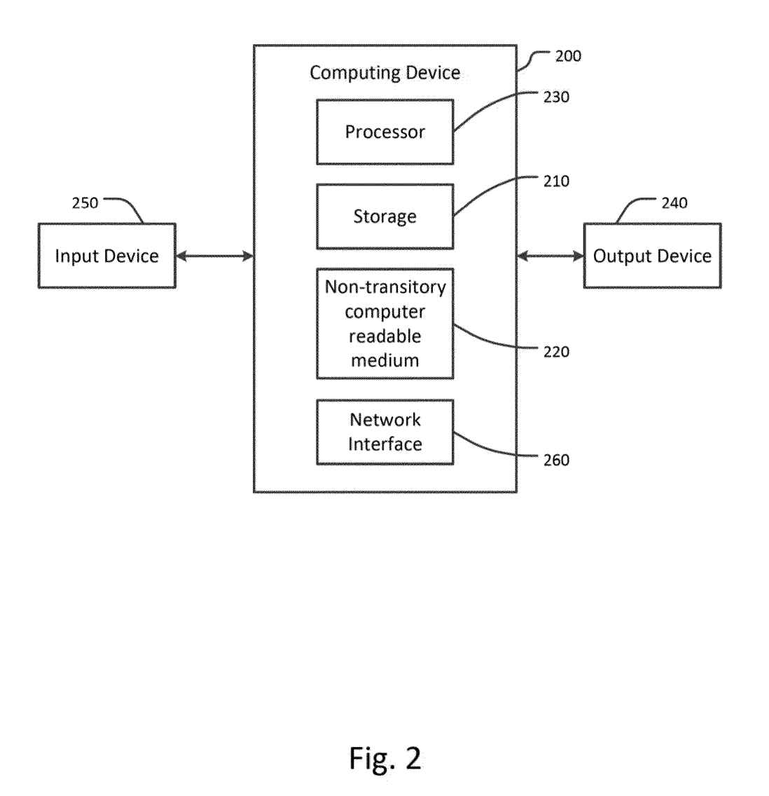

FIG. 2 is a block diagram representing an example computing device 200 that may be used to perform any of the techniques as variously described herein. The computing device 200 may be any computer system, such as a workstation, desktop computer, server, laptop, handheld computer, tablet computer (e.g., the iPad® tablet computer), mobile computing or communication device (e.g., the iPhone® mobile communication device, the Android™ mobile communication device, and the like), or other form of computing or telecommunications device that is capable of communication and that has sufficient processor power and memory capacity to perform the operations described herein. A distributed computational system may be provided comprising a plurality of such computing devices.

The computing device 200 includes one or more storage devices 210 and/or non-transitory computer-readable media 220 having encoded thereon one or more computer-executable instructions or software for implementing techniques as variously described herein. The storage device 210 may include a computer system memory or random access memory, such as a durable disk storage (which may include any suitable optical or magnetic durable storage device, e.g., RAM, ROM, Flash, USB drive, or other semiconductor-based storage medium), a hard-drive, CD-ROM, or other computer readable media, for storing data and computer-readable instructions and/or software that implement various embodiments as taught herein. The storage device 210 may include other types of memory as well, or combinations thereof. The storage device 210 may be provided on the computing device 200 or provided separately or remotely from the computing device 200. The non-transitory computer-readable media 220 may include, but are not limited to, one or more types of hardware memory, non-transitory tangible media (for example, one or more magnetic storage disks, one or more optical disks, one or more USB flash drives), and the like. The non-transitory computer-readable media 220 included in the computing device 200 may store computer-readable and computer-executable instructions or software for implementing various embodiments. The computer-readable media 220 may be provided on the computing device 200 or provided separately or remotely from the computing device 200.

The computing device 200 also includes at least one processor 230 for executing computer-readable and computer-executable instructions or software stored in the storage device 210 and/or non-transitory computer-readable media 220 and other programs for controlling system hardware. Virtualization may be employed in the computing device 200 so that infrastructure and resources in the computing device 200 may be shared dynamically. For example, a virtual machine may be provided to handle a process running on multiple processors so that the process appears to be using only one computing resource rather than multiple computing resources. Multiple virtual machines may also be used with one processor.

A user may interact with the computing device 200 through an output device 240, such as a screen or monitor, which may display one or more user interfaces provided in accordance with some embodiments. The output device 240 may also display other aspects, elements and/or information or data associated with some embodiments. The computing device 200 may include other input and/or output (I/O) devices 250 for receiving input from a user, for example, a keyboard or any suitable multi-point touch interface, a pointing device (e.g., a mouse, a user's finger interfacing directly with a display device, etc.). The computing device 200 may include other suitable conventional I/O peripherals.

The computing device 200 may include a network interface 260 configured to interface with one or more networks, for example, a Local Area Network (LAN), a Wide Area Network (WAN) or the Internet, through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 260 may include a built-in network adapter, network interface card, PCMCIA network card, card bus network adapter, wireless network adapter, USB network adapter, modem or any other device suitable for interfacing the computing device to any type of network capable of communication and performing the operations described herein. The network device 260 may include one or more suitable devices for receiving and transmitting communications over the network including, but not limited to, one or more receivers, one or more transmitters, one or more transceivers, one or more antennas, and the like.

The computing device 200 may run any operating system, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device 200 and performing the operations described herein. In an embodiment, the operating system may be run on one or more cloud machine instances.

In other embodiments, the functional components/modules may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number of embedded routines for carrying out the functionality described herein. In a more general sense, any suitable combination of hardware, software, and firmware can be used, as will be apparent.

Example Methodologies

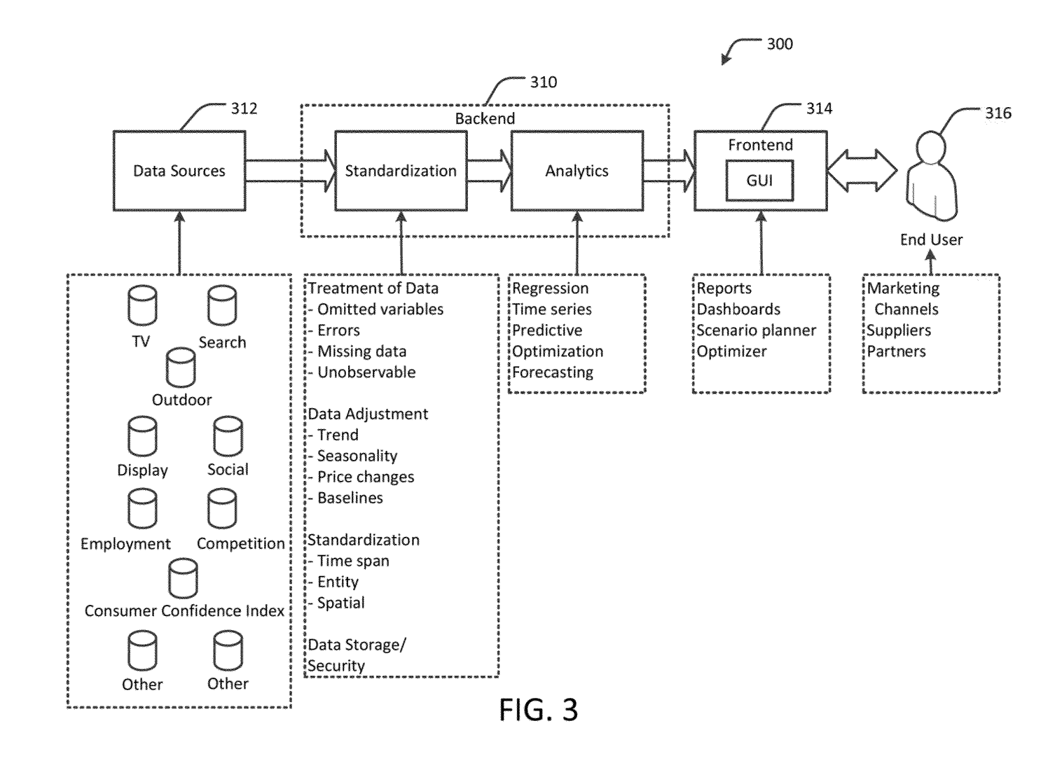

FIG. 3 illustrates an overview of an example methodology 300 for generating a marketing plan that may be used, in whole or in part, in conjunction with various embodiments. In some embodiments, the methodology 300 may be implemented, for example, by the analytics engine of FIG. 1. A backend 310 is configured to receive input data from one or more sources 312, such as marketing investment sources (e.g., TV, search, outdoor, display, social), external factors (e.g., employment, competition, consumer confidence index), and other suitable data sources. The backend 310 is further configured to interface with a frontend 314 and an end user 316. The end user 316, via a graphical user interface of the frontend 314, may provide the backend 310 with various types of information, including scenario data that defines, at least in part, a marketing campaign, a set of goals for the campaign, a set of constraints for the campaign, a time frame for the campaign, a set of desired marketing elements for the campaign, a desired mix of the marketing elements, a set of assumptions for the campaign, or any combination of these. The backend 310 is further configured calculate response factors corresponding to each of the marketing elements based on the input data, and to generate a marketing plan based on the scenario data. The marketing plan may include, for example, a list of marketing elements associated with the marketing campaign ordered in a flighting schedule according to the respective response factors. The frontend 314 is further configured to provide the marketing plan to the end user 316 via, for example, the graphical user interface. According to some embodiments, one or more frontends 314 may be implemented using various tools, such as Adobe Site Catalyst and Ad Lens. In this manner, the backend 310 can process information provided by one or more of the frontends 314, and send results back to the same or different frontends 314 for other decision and executional steps (e.g., for generating a marketing plan).

In some embodiments, the marketing plan can include an optimized, or ideal, mix of marketing elements across multiple channels, such as TV, print, display, paid search, etc., as defined by the end user 316 in a scenario. In other words, the marketing plan may include a list (or other display form, such as a table or report) describing various marketing resources that are allocated based on the input data (e.g., historical performance of the marketing resources) and the user-supplied scenario (e.g., a set of goals defined by product, marketing campaign and local market). Further, the marketing plan may describe the sequence and timing for deploying the respective marketing resources in accordance with the user-supplied scenario. In this manner, the marketing plan describes an optimal utilization of marketing resources that meet the goals of the end-user, as defined in the scenario. Such a scenario may define, for example, whether a product is a new product or an upgraded product, a brand-based marketing theme or a product-based marketing theme, a change in product positioning, a sale event or deal offer, a mega-sponsorship event, a holiday or non-holiday event, or a regional market rollout or a local market rollout, among other factors. It will be understood that some embodiments are not limited to a single scenario. For example, in some embodiments, each end user 316 may define several different scenarios from which the backend 310 can generate multiple marketing plans.

In some embodiments, the backend 310 is configured to automatically determine the marginal response factors of the marketing resources based on the input data received from the various sources 312. This process may include several steps, including detecting missing data and outlier data, applying business and statistical rules to the data, adjusting the data based on factors such as sales trends, seasonality, price changes, and baselines (e.g., the volume of sales not attributable to any marketing efforts), and standardizing the data so that the data are comparable (e.g., on the basis of time, entity, geography, etc.).

In some embodiments, the backend 310 is configured to generate the marketing plan in consideration of various factors. For example, new product launches may involve marketing in advance of the launch date of the new product. Such marketing helps build customer awareness of, and excitement for, the new product, which may focus demand for the new product on or near the launch date. This awareness and demand may be converted into sales through a loop or funnel process. Other factors, such as found in certain vertical markets (e.g., pharmaceutical products), may be modeled to predict market or segment share, which may be characterized as relative attraction methods.

According to some embodiments, the base volume of product sales is the volume of the product sold by the brand without marketing. Thus, for a given product p, local market m, and timeframe t, the base volume is equivalent to the units (or revenue) divided by the cross product of media effort (e.g., impressions weighted by elasticity for the touchpoint). The base volume represents existing customers in the marketplace who repeatedly purchase the same product even if there is no active marketing for the product. The base volume may move upward or downward (dynamically float) seasonally and may be affected by the economy or pricing. Touchpoint flighting for p, m, and t can be assigned using the elasticity patterns by touchpoint and timeframe. In some embodiments, for a given cohort, the priority ordering of touchpoints in a marketing plan includes a combination of the time lags associated with the touchpoint and the respective touchpoint elasticities adjusted for marginal costs. For optimization, execution of the marketing plan may include the next best option for expected marginal revenue less marginal cost for a given conversion probability. As used herein, the term “cohort” includes a set of experiences, events or other factors shared by a group of customers.

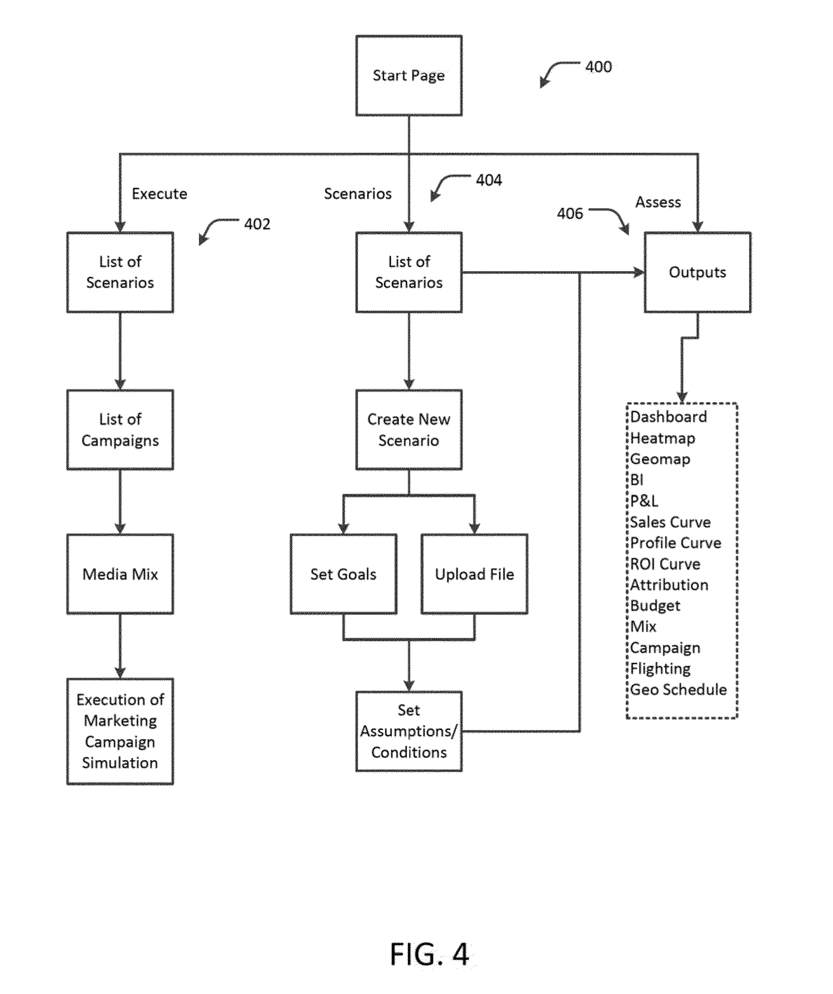

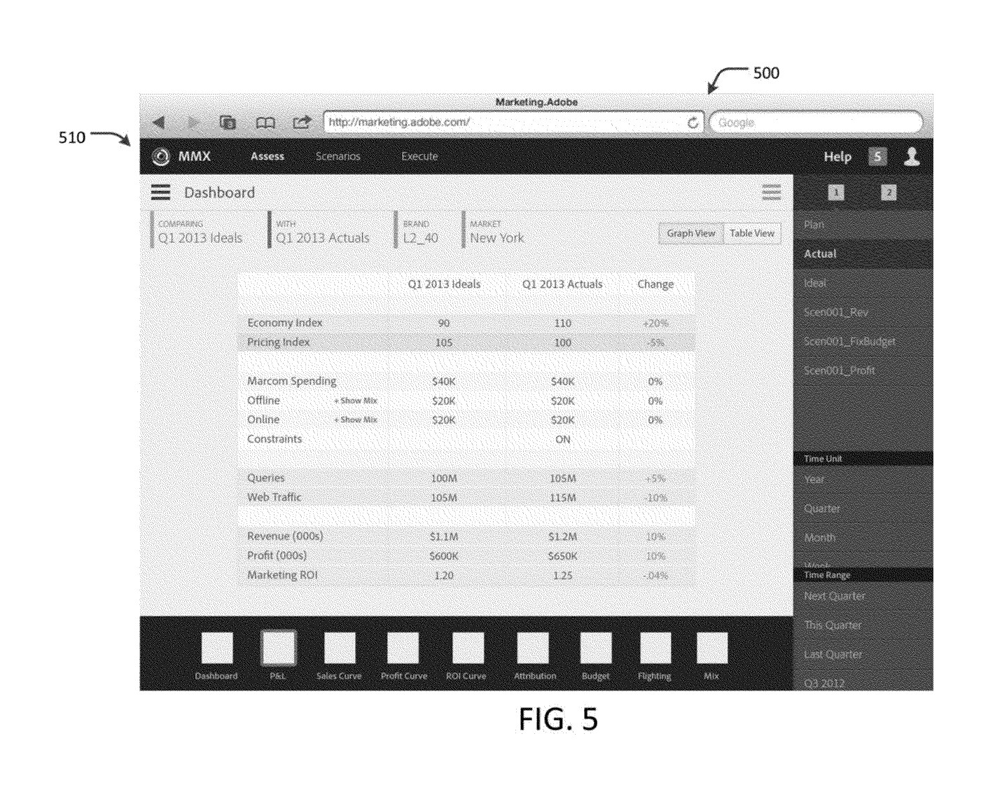

FIG. 4 illustrates a flow diagram of an example user workflow 400 in accordance with an embodiment. From a start page (e.g., a webpage or other suitable user interface), a user may proceed down a number of different flow paths, such as an execute path 402, a scenarios path 404, and an assess path 406. The user may select a path using a graphical user interface or other suitable user interface, such as described below with respect to FIG. 5. If the user selects to proceed down the execute path 402, the user is presented with a list of scenarios that have been previously defined. As mentioned above, each scenario can define the parameters of several dimensions, such as brands, local markets, campaigns and time frames that the user wishes to incorporate into a particular marketing campaign. The user may select any one of the scenarios. Next, the user is presented with a list of marketing campaigns that have been previously defined. Such campaigns may, for example, be organized by brand, market, or both. The user may select one of the marketing campaigns in which the selected scenario is to be executed. Next, the user is presented with a media mix representing one or more marketing resources (e.g., TV, print, web, social media, etc.) that may be employed in the marketing campaign. The marketing resources may be used to create individual touchpoints (e.g., points of contact between seller and buyer). The user may select one or more of these marketing resources. Next, a simulation of the marketing campaign can be executed by, for example, a third party application using the selected scenario, campaign and marketing resources. The simulation enables the user to see how the marketing campaign is expected to perform using the selected parameters and one or more model generated from various response factors based on historical performance of the marketing resources and other factors.

If instead the user selects to proceed down the scenarios path 404, the user is presented with the list of predefined scenarios. The user may choose to create a new scenario, in which goals and other parameters may be established either via a user interface or by uploading a suitable data file containing such goals and parameters (e.g., a spreadsheet). Examples of such goals and parameters include: percentage change in sales for a given brand or product during a marketing campaign, and budget constraints associated with certain categories of marketing resources (e.g., limits on total spending for online and offline resources, respectively). Next, the user may set additional assumptions or conditions, which provide limits and bounds to the new scenario. Examples of such assumptions or conditions include: maximum or minimum budget constraits over a given time period within the marketing campaign for a particular marketing resource (e.g., TV, magazine, newspaper, outdoor signage, etc.), and start and end times for deploying a particular marketing resource. Next, the user can select from a number of different formats for viewing data associated with the newly created scenario, such as a dashboard, heatmap, geomap, business intelligence (BI), profile and loss (P&L), sales curve, profile curve, return on investment (ROI) curve, attribution, budget, mix, campaign, flighting, geographic schedule, etc. Alternatively, if the user selects to proceed down the assess path 406 rather than the scenarios path 404, the user may also select from the different formats for viewing data without having to redefine the scenario.

FIG. 5 is an example graphical user interface 500 illustrating a dashboard page, in accordance with an embodiment. The user interface 500 includes selectors 510 (e.g., Assess, Scenarios, Execute) for selecting a workflow path, such as described above with respect to FIG. 4. The user interface 500 further includes various other types of data 520 that is associated with a particular scenario. Such an interface may, in some cases, be user-customizable to display the types of data of interest.

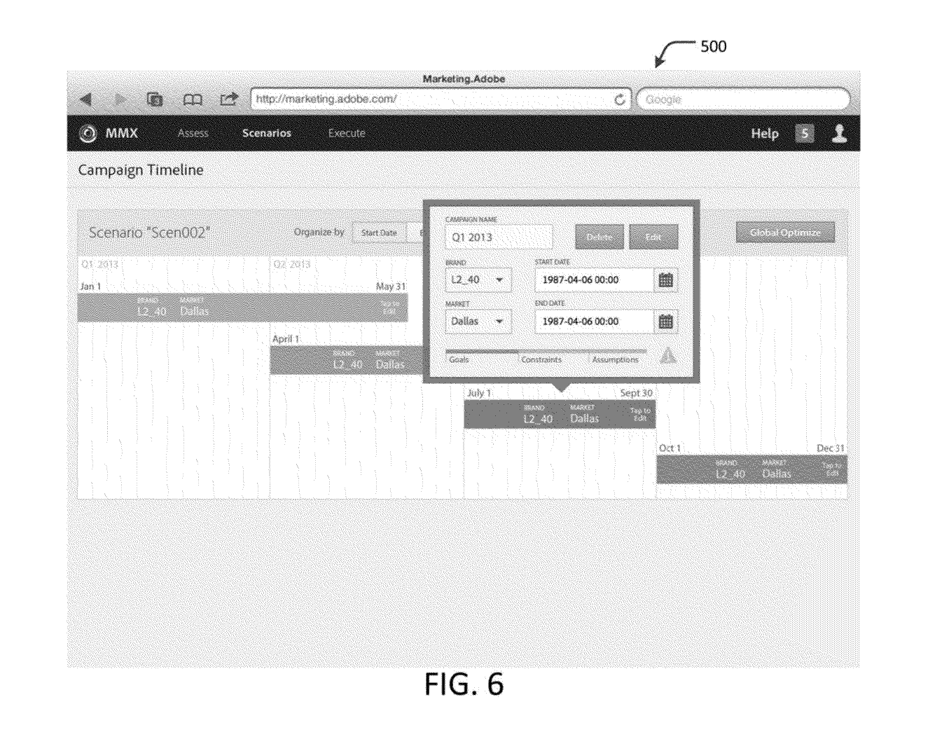

FIG. 6 is another example graphical user interface 600 illustrating a campaign timeline, in accordance with an embodiment. The campaign timeline may include, for example, a name, a brand, a market, a start date and an end date associated with a particular scenario.

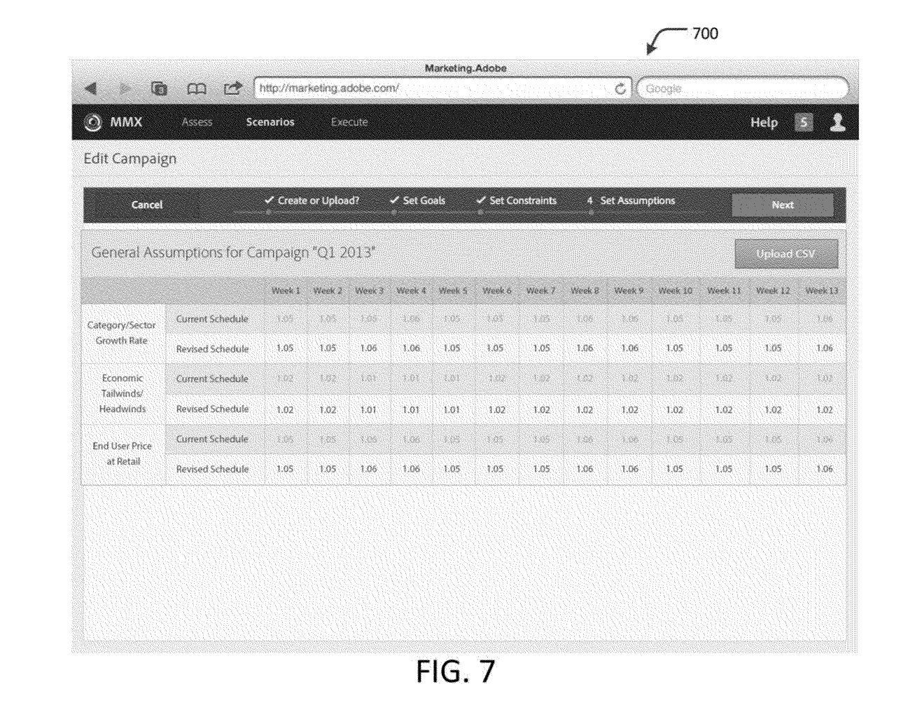

FIG. 7 is another example graphical user interface 700 illustrating a campaign editor, in accordance with an embodiment. The campaign editor may include, for example, various data associated with a marketing campaign, such as growth rate, economic tailwinds/headwinds, end user price at retail, or other suitable types of data that can be viewed or manipulated via the interface 700.

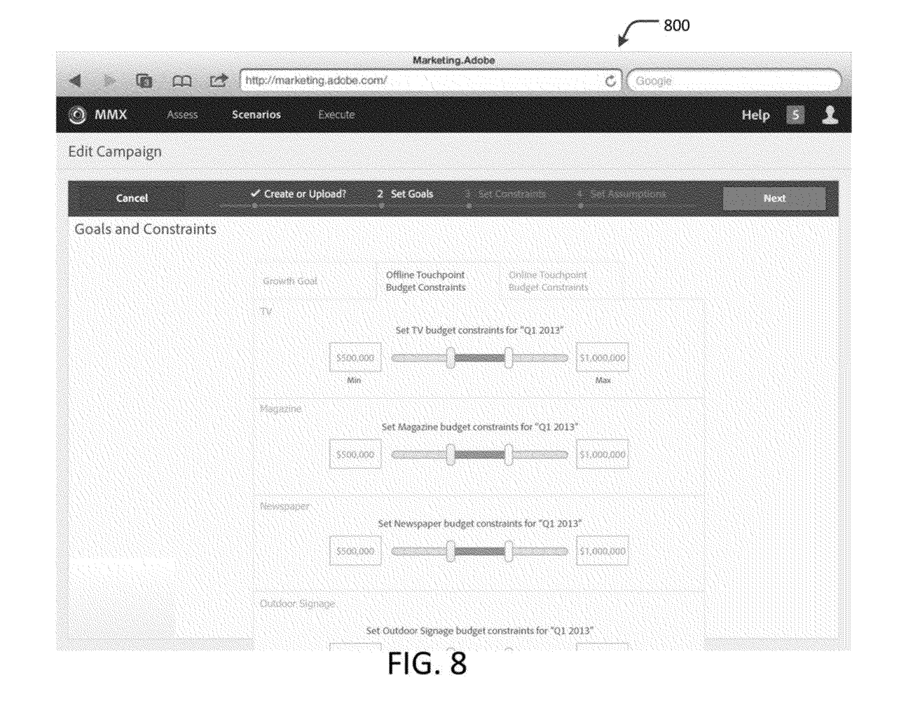

FIG. 8 is another example graphical user interface 800 illustrating a campaign editor, in accordance with an embodiment. The campaign editor may include, for example, various input controls or data fields for setting, changing or viewing data associated with growth goals or other parameters of a pre-defined scenario.

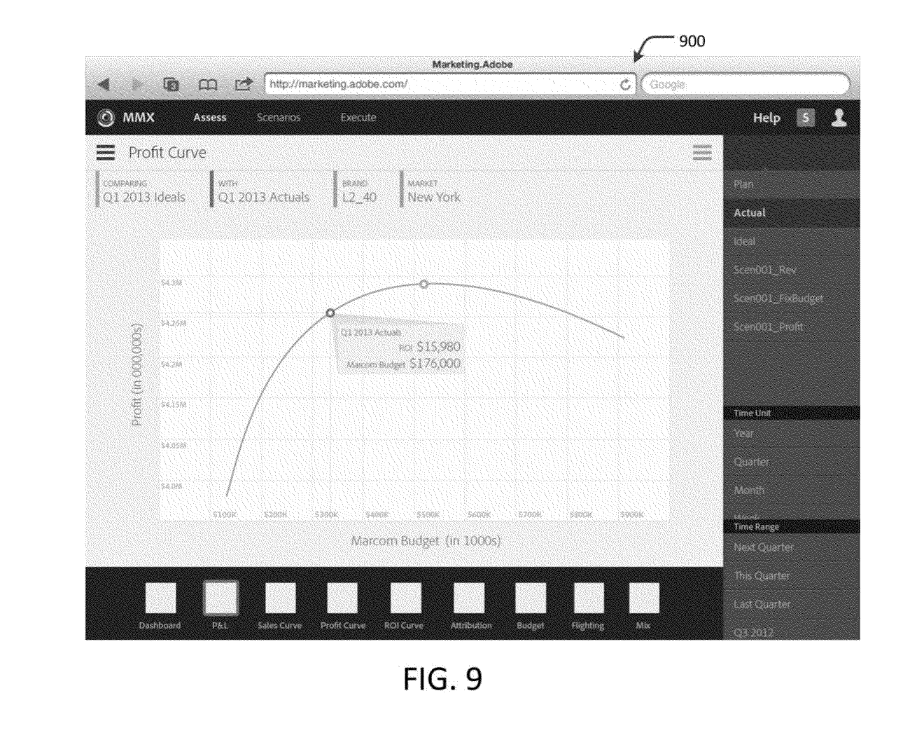

FIG. 9 is another example graphical user interface 900 illustrating a profit curve viewer, in accordance with an embodiment. The profit curve viewer may be configured, for example, to display various graphs of data (e.g., profit versus budget or spending) associated with a pre-defined scenario chosen by the user. Other non-limiting examples of data that can be displayed in the interface 900 include profit and loss data, return on investment data, sales data, and fighting data.

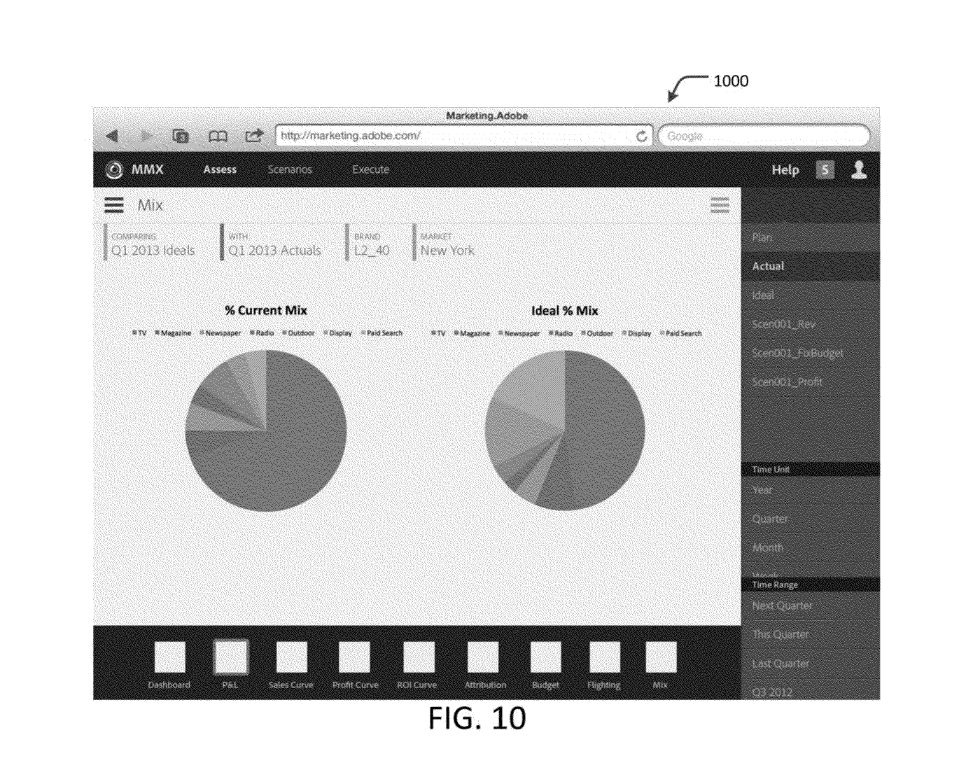

FIG. 10 is another example graphical user interface 1000 illustrating a spending mix viewer, in accordance with an embodiment. The spending mix viewer may be configured, for example, to display various graphs of data (e.g., a current mix and an ideal mix) associated with a pre-defined scenario chosen by the user.

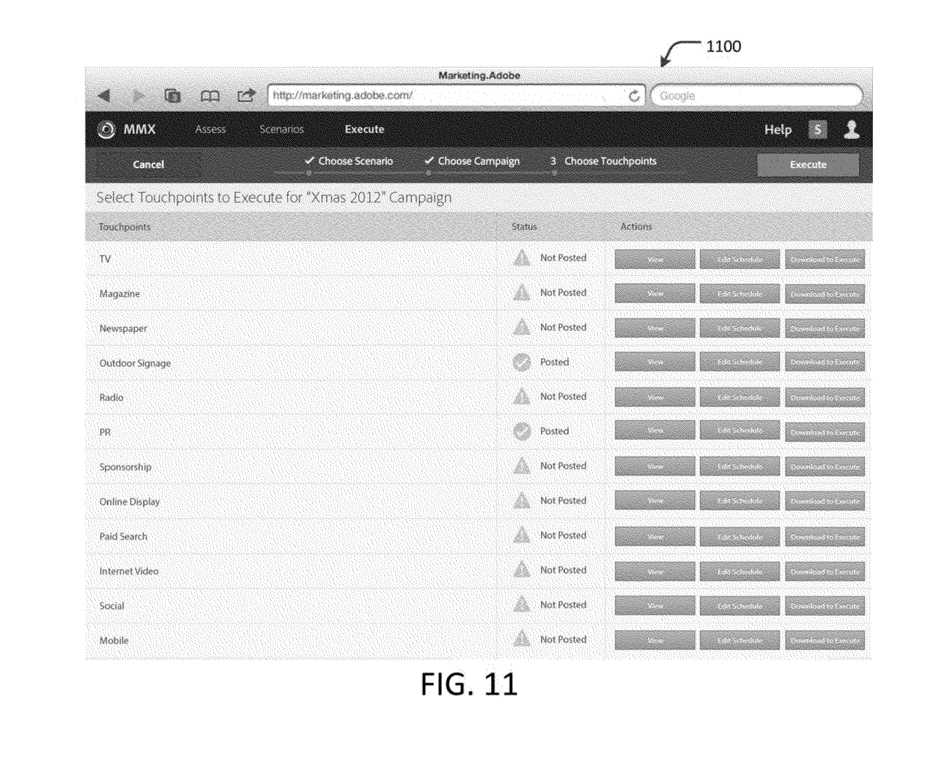

FIG. 11 is another example graphical user interface 1100 illustrating a touchpoint viewer, in accordance with an embodiment. The touchpoint viewer may be configured, for example, to display various touchpoints and related statuses associated with a pre-defined scenario chosen by the user, and to provide various input controls or data fields for viewing, editing or otherwise manipulating data associate with the respective touchpoints.

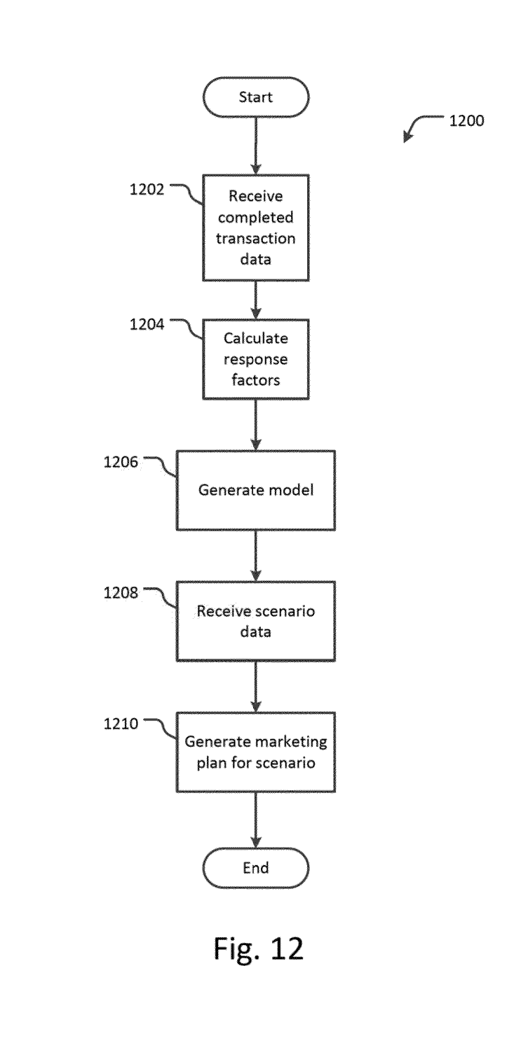

FIG. 12 is a flow diagram of an example methodology 1200 for generating a forward-looking, goal-seeking marketing plan, in accordance with an embodiment. The method 1200 begins by receiving 1202 result data representing quantified results of customer interactions with a plurality of marketing elements. The method 1200 continues by calculating 1204 one or more response factors corresponding to each of the marketing elements based on the result data. The method 1200 continues by generating 1206 a model based on the response factors. The method 1200 further includes receiving 1208 scenario data representing a marketing campaign scenario. The marketing campaign scenario can be associated with at least one of the marketing elements. The method 1200 continues by generating 1210 a marketing plan based on the model and the scenario data. The marketing plan includes at least one of the marketing elements. In some cases, the scenario data includes a marketing goal, a budget constraint, a resource constraint and an economic assumption. In such cases, the marketing plan can include a mix of the marketing elements that are predicted, based on the model, to achieve the marketing goal in light of the budget constraint, the resource constraint and the economic assumption. These may be user-provided parameters that constrain various aspects of a marketing plan, such as which marketing elements are used, when the marketing elements are used, and to what extent the marketing elements are used. In some cases, the scenario data further includes a set of parameters, including a brand, a product, a touchpoint, a geographical market, a time frame, or any combination thereof. In such cases, the marketing plan includes the marketing elements corresponding to the parameters.

In some embodiments, the marketing plan includes a flighting schedule arranged such that the marketing elements having the highest respective response factors are scheduled to occur earlier in time than the marketing elements having lower respective response factors. In some cases, the marketing plan includes marketing elements having a marginal cost that does not exceed the marginal revenue. In some cases, each response factor is a function of a marginal revenue and a marginal cost of the at least one marketing element.

Numerous embodiments will be apparent in light of the present disclosure, and features described herein can be combined in any number of configurations. One example embodiment of the invention provides a computer-implemented method. The method includes receiving result data representing quantified results of customer interactions with a plurality of marketing elements; calculating, by a processor, response factors corresponding to each of the marketing elements based on the result data; generating a model based on the response factors; receiving scenario data representing a marketing campaign scenario, the marketing campaign scenario being associated with at least one of the marketing elements; and generating, by the processor, a marketing plan based on the model and the scenario data, the marketing plan including the at least one marketing elements. In some cases, the scenario data includes a marketing goal, a budget constraint, a resource constraint and an economic assumption, and wherein the marketing plan includes a mix of the marketing elements that are predicted, based on the model, to achieve the marketing goal in light of the budget constraint, the resource constraint and the economic assumption. In some such cases, the scenario data further includes a set of parameters, the parameters including at least one of a brand, a product, a touchpoint, a geographical market, and a time frame, and wherein the marketing plan includes the marketing elements corresponding to the parameters. In some cases, the marketing plan includes a flighting schedule arranged such that the marketing elements having the highest respective response factors are scheduled to occur earlier in time than the marketing elements having lower respective response factors. In some cases, each response factor is a function of a marginal revenue and a marginal cost of the at least one marketing element. In some such cases, the marketing plan includes marketing elements having a marginal cost that does not exceed a marginal revenue. In some cases, the method includes assigning a common tag to at least a portion of the result data using a data dictionary, and wherein the response factors are calculated based at least in part on the portion of the result data.

The foregoing description and drawings of various embodiments are presented by way of example only. These examples are not intended to be exhaustive or to limit the invention to the precise forms disclosed. Numerous variations will be apparent in light of this disclosure. Alterations, modifications, and variations will readily occur to those skilled in the art and are intended to be within the scope of the invention as set forth in the claims.

What is claimed is:

1. A computer-implemented method comprising:
receiving, by a processor, result data representing quantified results of customer interactions with a plurality of marketing elements;
calculating, by the processor, response factors corresponding to each of the marketing elements based on the result data;
generating, by the processor, a model based on the response factors;
receiving, by the processor, scenario data representing a marketing campaign scenario, the marketing campaign scenario being associated with at least one of the marketing elements; and
generating, by the processor, a marketing plan based on the model and the scenario data, the marketing plan including the at least one marketing elements.

2. The method of claim 1, wherein the scenario data includes a marketing goal, a budget constraint, a resource constraint and an economic assumption, and wherein the marketing plan includes a mix of the marketing elements that are predicted, based on the model, to achieve the marketing goal in light of the budget constraint, the resource constraint and the economic assumption.

3. The method of claim 2, wherein the scenario data further includes a set of parameters, the parameters including at least one of a brand, a product, a touchpoint, a geographical market, and a time frame, and wherein the marketing plan includes the marketing elements corresponding to the parameters.

4. The method of claim 1, wherein the marketing plan includes a flighting schedule arranged such that the marketing elements having the highest respective response factors are scheduled to occur earlier in time than the marketing elements having lower respective response factors.

5. The method of claim 1, wherein each response factor is a function of a marginal revenue and a marginal cost of the at least one marketing element.

6. The method of claim 5, wherein the marketing plan includes marketing elements having a marginal cost that does not exceed a marginal revenue.

7. The method of claim 1, further comprising assigning a common tag to at least a portion of the result data using a data dictionary, wherein the response factors are calculated based at least in part on the portion of the result data.

8. A system comprising:
a storage;
a processor operatively coupled to the storage, the processor configured to execute instructions stored in the storage that when executed cause the processor to carry out a process comprising:
receiving result data representing quantified results of customer interactions with a plurality of marketing elements;
calculating response factors corresponding to each of the marketing elements based on the result data;
generating a model based on the response factors;
receiving scenario data representing a marketing campaign scenario, the marketing campaign scenario being associated with at least one of the marketing elements; and
generating a marketing plan based on the model and the scenario data, the marketing plan including the at least one marketing elements.

9. The system of claim 8, wherein the scenario data includes a marketing goal, a budget constraint, a resource constraint and an economic assumption, and wherein the marketing plan includes a mix of the marketing elements that are predicted, based on the model, to achieve the marketing goal in light of the budget constraint, the resource constraint and the economic assumption.

10. The system of claim 9, wherein the scenario data further includes a set of parameters, the parameters including at least one of a brand, a product, a touchpoint, a geographical market, and a time frame, and wherein the marketing plan includes the marketing elements corresponding to the parameters.

11. The system of claim 8, wherein the marketing plan includes a flighting schedule arranged such that the marketing elements having the highest respective response factors are scheduled to occur earlier in time than the marketing elements having lower respective response factors.

12. The system of claim 8, wherein each response factor is a function of a marginal revenue and a marginal cost of the at least one marketing element.

13. The system of claim 12, wherein the marketing plan includes marketing elements having a marginal cost that does not exceed a marginal revenue.

14. The system of claim 8, wherein the process further comprises assigning a common tag to at least a portion of the result data using a data dictionary, and wherein the response factors are calculated based at least in part on the portion of the result data.

15. A non-transient computer program product having instructions encoded thereon that when executed by one or more processors cause a process to be carried out, the process comprising:
receiving result data representing quantified results of customer interactions with a plurality of marketing elements;
calculating response factors corresponding to each of the marketing elements based on the result data;
generating a model based on the response factors;
receiving scenario data representing a marketing campaign scenario, the marketing campaign scenario being associated with at least one of the marketing elements; and
generating a marketing plan based on the model and the scenario data, the marketing plan including the at least one marketing elements.

16. The computer program product of claim 15, wherein the scenario data includes a marketing goal, a budget constraint, a resource constraint and an economic assumption, and wherein the marketing plan includes a mix of the marketing elements that are predicted, based on the model, to achieve the marketing goal in light of the budget constraint, the resource constraint and the economic assumption.

17. The computer program product of claim 16, wherein the scenario data further includes a set of parameters, the parameters including at least one of a brand, a product, a touchpoint, a geographical market, and a time frame, and wherein the marketing plan includes the marketing elements corresponding to the parameters.

18. The computer program product of claim 15, wherein the marketing plan includes a flighting schedule arranged such that the marketing elements having the highest respective response factors are scheduled to occur earlier in time than the marketing elements having lower respective response factors.

19. The computer program product of claim 15, wherein each response factor is a function of a marginal revenue and a marginal cost of the at least one marketing element.

20. The computer program product of claim 15, wherein the process further comprises assigning a common tag to at least a portion of the result data using a data dictionary, and wherein the response factors are calculated based at least in part on the portion of the result data.
